(19) United States
(12) Patent Application Publication
(10) Pub. No.: US 2012/0171086 A1
(43) Pub. Date: Jul. 5, 2012

(54) Separation Body for Three-Dimensional Chromatography

(75) Inventors: Sebastiaan Eeltink, Brussels (BE); Peter J. Schoenmakers, Oudkarspel (NL)

(73) Assignee: DIONEX BENELUX B.V., Amsterdam (NL)

(21) Appl. No.: 13/394,502

(22) PCT Filed: Sep. 7, 2010
(86) PCT No.: PCT/EP10/05470

§ 371 Date: Mar. 6, 2012

(30) Foreign Application Priority Data
Sep. 7, 2009 (DE) 10 2009 040 182.2

(51) Int. Cl. B01D 15/08; G01N 30/46

(52) U.S. Cl. 422/527; 73/61.53

(57) ABSTRACT

A separation body for three-dimensional chromatography, which provides at least one predefinable individual retention capacity in each spatial direction, for an analyte transported in a mobile phase in the respective direction.

The present invention relates to a separation body for carrying out chromatographic methods.

Separation bodies for chromatography are known as such from prior art. For traditional methods, a mobile phase containing specific components to be separated passes through columns, for example. Specific interactions of the analytes with the stationary phase lead to a separation of the individual components emerging from the column with different time. lags. The performance of spatial 3D chromatography greatly exceeds that of LC×LC×LC based on a three-column strategy.

Usually, the mobile phase migrates through the separation body as a result of a pressure difference applied. Alternatively, an electro-osmotic flow may be generated to drive the mobile phase through the separation body by applying an electric voltage. In this case, surface charges must be present at places where the electro-osmotic flow is desired.

The principle of three-dimensional chromatography is known from patent document U.S. Pat. No. 4,469,601. There, a two-dimensional chromatography is performed a surface or in a thin two-dimensional layer. The plate is permeable, and when dried, is placed against a cube of material. Then, a solvent is forced through the plate and through the cube in order to use the retention mechanism that is provided in that third dimension. This way of proceeding is troublesome, and the structure of the body is complex.

It is therefore the object of the invention to provide a means for simple three-dimensional chromatography.

The object is achieved by a separation body as defined in claim 1.

The invention is based on the idea that different retention mechanisms can be implemented inside a three-dimensional separation body so as to make it possible to better separate the components searched for. Advantageously, the body does not have to be assembled or disassembled between the individual phases of three-dimensional chromatography (first separation in direction X of the body, then second separation in a direction Y vertical to X and finally a third separation in direction Z perpendicular to the two other axes). Instead, the body substantially keeps its shape throughout the entire process. According to the invention, in order to better separate the components inside the separation body (block), suitable retention mechanisms are installed for each direction X, Y, Z. This makes it possible to carry out a three-dimensional chromatography along three orthogonal directions inside one body. Preferably, this is done sequentially, i.e. first in the direction X, then in the direction Y and finally in the direction Z. Methods are conceivable, however, in which a separation is effected in two of the three directions of space at the same time.

The practical use of the separation body according to the invention provides that a mobile phase carrying the components to be separated is introduced into the separation body along a first dimension, preferably along an edge of the body that is cubic, for example. Suitably, for this first step, the flow of the mobile phase is limited to the associated direction X in the best way possible so that a distribution of the components searched for depending on the retention mechanism chosen or predefined for this direction of flow is obtained in the X-direction. In the subsequent second stage of chromatography in the Y-direction, which is carried out perpendicularly to the one-dimensional distribution, the components separated before are subjected to another separation on the basis of the retention mechanism prevailing in the Y-direction. The same applies to the subsequent third step in the Z-direction, so a three-dimensional distribution of the components inside the separation body is finally obtained (instead of a distribution of the components in the Z-direction in the third step of chromatography, a separation “in time” may also be effected here, meaning that the components emerge from the body at a boundary surface thereof with a difference in time lag in the Z-direction. In this case, separation in the third dimension is effected “in time”, whereas otherwise separations in all three dimensions are effected “in space”).

An essential aspect of the present invention for multi-dimensional separations is that the individual separation stages should be as different as possible. Ideally, the retention mechanisms are completely independent, in which case the separation stages can be called orthogonal. Accordingly, the invention focuses on providing individual retention mechanisms for each of the three dimensions X, Y, Z within the separation body. With the preset or dynamically changeable individual retention mechanisms, the components searched for can be eluated from the mobile phase in each direction according to different criteria and with correspondingly different spatial distribution (or temporal, provided that the last separation is effected “in time”).

In the prior art, the separation body is assembled successively in the course of the individual separation steps. In particular, after the second step of separation (separation of the components in the plane X-Y), a plate used for this purpose is attached to a three-dimensional block which in turn has a predefined retention capacity. After the assembly, the mobile phase is allowed to pass through the entire body in a direction perpendicular to the plate so as to achieve the separation in the third dimension Z.

As opposed to this, the separation body according to the invention is completely assembled from the beginning. According to a variant of an embodiment of the invention, the suitably different retention mechanisms are already made possible individually for each direction of flow at this point of time. An alternative embodiment allows to dynamically change the retention mechanisms with the aid of different physical or chemical effects, as will be shown below. Such a separation body according to the invention makes it possible to save considerable time and efforts due to automation, when carrying out a three-dimensional chromatography as compared to the prior art. Moreover, the separation body can also be manufactured and used in small sizes (length of edges clearly shorter than e.g. 50 mm), which facilitates the handling thereof considerably.

A particularly simple embodiment of the invention provides that several separation media having different retention capacities are assembled to form the separation body, so a defined retention mechanism works in each direction X, Y, Z. Here, it is basically also possible to use separation media of the same kind for different directions as long as each dimension has the desired retention capacity due to a suitable pretreatment, which should appropriately differ from the two other retention capacities. For example, channels with pillars are conceivable, whose surfaces are pretreated by etching or coating with porous layers in a suitable way and which are adjusted to a desired retention capacity in a specific direction. Alternatively or additionally, the separation body may have micromachined structures, for example in the form of a silicone wafer etched with micropillar structures. It is also possible to provide or deliberately arrange a gel in the separation body as a suitable separation medium so as to bring about a suitable retention capacity in a desired direction of space. Moreover, pseudo-stationary phases, such as micelles, may be used just as much as packed beds, monolithic stationary phases, self-assembled micro- and nanostructures or monolithic embedded particles. In fact, according to one aspect of the invention, the entire separation body may be monolithically formed while different retention mechanisms may be implemented dynamically for each direction X, Y, Z. However, according to one aspect of the invention, the separation body may be assembled from different elements or block parts, each element or block part basically being monolithic and providing its own retention mechanism, which could in addition be depending on the spatial orientation of the element inside the completed block.

In general, any suitable separation mechanism may be used to achieve the desired retention mechanism inside the separation body preferably acting in one specific direction X, Y or Z. While the separation is based on size exclusion, other separation mechanisms like hydrophobic interaction, ion exchange, affinity or reversed phase separation may also be adapted with suitable separation media inside the block.

As already mentioned, the body according to the invention may either contain different separation media, each having a specific separation mechanism. It is also possible, however, that separation media of the same kind are provided inside the block, and that they have a purposive and individually different retaining capacity for a specific direction of space either because of the spatial orientation of their inner structure and/or because of a physical or chemical treatment. What is conceivable, for example, is a substantially one-dimensional separation along a narrow edge of a separation body in the X-direction. A substantially two-dimensional micromachined structure could border on this in the Y-direction across the entire length X. Adjoining this plane X-Y, another micromachined structure or another one of the aforesaid separation media or of other separation media well-known to the person skilled in the art could be arranged in the Z-direction so as to effect a retention mechanism determined thereby in the Z-direction.

The combination of different separation media inside the separation body only constitutes a variant of embodying the body according to the invention. Alternatively, the separation body may also be formed substantially homogeneously by a single separation medium which, however, has the desired different retention mechanisms in different directions of space. For example, a homogeneous medium could have different permeabilities depending on the direction of space, whereby correspondingly different retention mechanisms would be achieved.

According to the invention, the different retention capacities in the directions X, Y and Z of space are to be predefinable by deliberately forming the surface properties or the porosities inside the separation body, which can be realized either in a permanent or in a dynamically changeable way.

A special aspect of the invention relates to the separation body's characteristic of being able to dynamically change the surface properties or porosities of a separation medium inside the body without exchanging the separation medium itself for this purpose. Advantageously, dynamically changing the retention capacity in a specific direction X, Y or Z allows a temporal or local adjustment of the separation body to the component to be detected, respectively, without the necessity of physically exchanging the separation body or portions thereof for this purpose. Instead, the retention capacity is influenced by chemical or physical action on the separation body. For example, independent retention mechanisms can be realized by dynamically generating different stationary surfaces (in-situ). Such selectivity tuning methods include hydrophobicity and inherent cation-exchange capacity of a C18 phase, porous columns in the interactive and size-exclusion modes by changing the mobile phase or thermally or electrically controllable phases. These methods allow to adjust the properties of the surfaces within the separation body, thereby changing the retention mechanisms. For example, the surface properties of certain zones within the separation body may be changed dynamically by a reagent added to the mobile phase, which causes specific interactions in the zones that lead to a change of the surface properties there. As an example of the latter, a C18 phase can be used for reversed-phase separations, but it can also be changed into a “dynamic anion exchanger” if a positively charged ion-pairing reagent is added to the mobile phase. Another example is the use of porous columns in the interactive and size-exclusion modes by changing the mobile phase.

Another way to cause a change in retention capacity would be to cause light-induced reaction in certain zones of the body or to thermally or electrically control certain zones inside the body.

Each of these measures makes it possible to deliberately change the surface properties or the retention capacity of the separation body in the zone or direction concerned, respectively. This has the special advantage that the outwardly unchanged separation body is “programmable” with a respectively different retention capacity at different times or for different directions of flow X, Y, or Z. Thus, even a separation body that is configured to be substantially homogeneous or monolithic and whose retention capacity would at first be the same in each direction of space could receive a specific different retention capacity considered advantageous for a specific effect of separation, respectively, for the individual stages or dimensions of three-dimensional chromatography.

This kind of “programming” does not have to relate to the entire separation body. By means of light-induced reaction, for example, a zone defined inside the separation body (for example, a cubic zone) could be adjusted to a specific retention capacity if this retention capacity appears to be appropriate exactly in this zone. This could be the case, for example, if specific components having undergone a two-dimensional separation in the plane X-Y require the retention capacity programmed in the aforesaid zone for the additional separation in the Z-direction, but maybe not along the entire Z-axis. For other components in the plane X-Y, however, which do not pass through the aforesaid zone when flowing through the separation body in the Z-direction, the retention capacity existing outside this zone could be sufficient for the further separation. Of course, it is also possible to arrange different zones having different retention capacities, respectively, next to one another or on top of one another inside the separation body.

Finally, it is also conceivable to “program” different zones with correspondingly different retention capacities in succession along a direction X, Y or Z of the separation body. Thus, for this single direction already, a kind of multi-dimensional separation would be achieved. If one proceeds accordingly in the other directions Y and Z, a multitude of different retention capacities inside a three-dimensional separation body can thus be realized so that the components separated, respectively, can be analyzed even more specifically.

Other advantageous embodiments are defined in the subclaims.

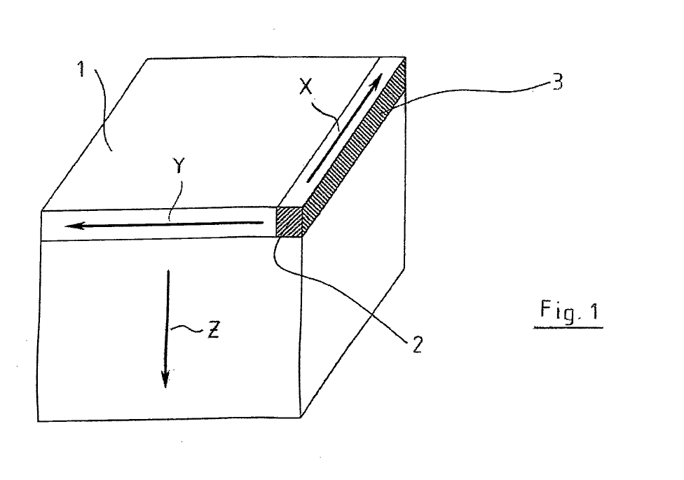

In the following, an embodiment of a separation body according to the invention will be described in greater detail with the aid of an example shown in FIG. 1. As shown in FIG. 1, a spatial separation body 1 according to the invention extends in three directions X, Y, Z, that are perpendicular to one another. Even though the body is designed to be monolithic, it provides a specific retention mechanism in each of the directions X, Y, Z.

To perform three-dimensional chromatography, the mobile phase is first introduced to the body through a limited upper edge area 2, which is illustrated in FIG. 1 in a disproportionate, enlarged way. Preferably, the mobile phase will penetrate the body 1 only in the first direction X during the first step of the method, along an upper edge of the body, without any mobile phase moving towards the other directions Y and Z.

During this first step, a separation of components along the X-Axis of the block will occur according to the retention mechanism foreseen in that direction. Preferably, the components will distribute individually along that first axis (“separation in space”).

After this first step, a mobile phase is introduced to penetrate the upper edge of the body 2 in the Y-direction, perpendicular to the distribution of the first step and along the entire length X through a narrow strip 3. The phase will flow in the Y-direction, preferable without any variations into the other direction X or Z, and effect an additional separation in this second dimension of those components, which were located at a specific X-position after the first step. As a result, the component will further be separated in another “separation in space” across an X-Y-Area, which could be the upper surface of the body 1 of FIG. 1.

The third separation step includes penetration of the body perpendicular to the X-Y-surface, that has undergone the previous step. A mobile phase is forced through the body in the Z-direction, causing another separation of the components which were located at specific X-Y-positions after the second step of the three-dimensional chromatography.

This separation may again occur “in space”, ending up with a distinct distribution of components along all three direction X, Y and Z of the body. Another type of separation (“in time”) occurs when the components are driven through the body entirely for this last step, but emerge from it at different points of time due to the retention mechanism chosen in that Z-direction.

1. A separation body for three-dimensional chromatography, which extends in three directions (X, Y, Z) in space preferably perpendicular to one another, said separation body having at least one predefinable individual retention capacity (Rₓ, R_{y}, R_{z}) in each direction (X, Y, Z), respectively, for an analyte transported in a mobile phase in the respective direction (X, Y, Z), wherein
said separation body is formed as a monolithic unit, the separation body further being provided
i) with open or coated channels, or
ii) with monolithic stationary phases, or
iii) with pseudo-stationary phases, particularly micelles, or
iv) as a micromachined structure, or
v) with packed beds, or
vi) with self-assembled micro- and nanostructures.

2. The separation body according to claim 1, wherein at least one of the retention mechanisms (Rₓ, R_{y}, R_{z}) is set by preset surface properties or porosities inside the separation body.

3. The separation body according to claim 2, wherein at least one of the retention mechanisms (Rₓ, R_{y}, R_{z}) can be changed dynamically by changing the characteristics of the pore diameter.

4. A separation body according to claim 3, wherein the surface properties can be changed dynamically, for example with respect to hydrophobicity or inherent cation exchange capacities of silica C18 materials.

5. The separation body according to claim 4, wherein the surface properties can be changed dynamically
a) by a reagent added to the mobile phase, or
b) by light-induced reaction at predefinable zones of the separation body, or
c) by thermally or electrically controllable zones within the body, or
d) by manipulating surface charges to create electro-osmotic flow,

6. The separation body according to the claim 5, wherein, in item d), the surface charges are generated dynamically and they are controllable by selection of the mobile phase composition.
